(19) United States
(12) Patent Application Publication
(10) Pub. No.: US 2026/0203873 A1
(43) Pub. Date: Jul. 16, 2026

(54) IMAGE NOISE REDUCTION METHOD AND IMAGE PROCESSING DEVICE

(71) Applicant: Cupola360 INC., Hsinchu City (TW)

(72) Inventor: Hsin-Hui Chen, Hsinchu City (TW)

(73) Assignee: Cupola360 INC., Hsinchu City (TW)

(21) Appl. No.: 19/054,899

(22) Filed: Feb. 16, 2025

(30) Foreign Application Priority Data
Jan. 15, 2025 (TW) 114101641

(51) Int. Cl. G06T 5/70; G06T 3/40; G06T 7/246

(52) U.S. Cl. CPC G06T 5/70; G06T 3/40; G06T 7/248

(57) ABSTRACT

An image noise reduction method and an image processing device are provided. The method includes: obtaining a t-th input image and a t-th reference image; determining a first weight map based on the t-th input image and the t-th reference image; using the t-th input image as a guidance image to perform a guided filtering operation on the first weight map to generate a second weight map; and performing a temporal filtering operation on the t-th input image and the t-th reference image based on the second weight map to generate a t-th output image.

### CROSS-REFERENCE TO RELATED APPLICATION

This application claims the priority benefit of Taiwan application serial no. 114101641, filed on Jan. 15, 2025. The entirety of the above-mentioned patent application is hereby incorporated by reference herein and made a part of this specification.

### BACKGROUND

### Technical Field

The disclosure relates to an image processing method, and particularly relates to an image noise reduction method and an image processing device.

### Description of Related Art

Currently, many video analysis applications (such as video surveillance, face recognition, and target tracking) have increasingly higher requirements for image quality to ensure analysis accuracy and meet the observation needs of the human eye. However, in high-noise environments, especially in low-light scenes, image quality often degrades significantly, thus affecting the reliability of analysis results. In order to improve image quality, temporal noise reduction (TNR) processing of videos has become a crucial technology.

When performing temporal noise reduction processing, accurate motion detection is the foundation for achieving the following two key objectives: (1) achieving efficient noise reduction effects in stationary areas; (2) avoiding ghost effects on moving objects, especially when processing objects with subtle movements.

Based on this, for those skilled in the art, how to design a means that may improve the image quality and analysis accuracy of TNR through accurate motion detection is actually an important issue.

### SUMMARY

In view of this, the disclosure provides an image noise reduction method and an image processing device, which may be used to solve the above technical problems.

An embodiment of the disclosure provides an image noise reduction method, which is executed by an image processing device, including: obtaining a t-th input image and a t-th reference image, where t is a time index value; determining a first weight map based on the t-th input image and the t-th reference image; using the t-th input image as a guidance image to perform a guided filtering operation on the first weight map to generate a second weight map; and performing a temporal filtering operation on the t-th input image and the t-th reference image based on the second weight map to generate a t-th output image.

An embodiment of the disclosure provides an image processing device, including a memory circuit and an image processor. The memory circuit stores a program code. The image processor is coupled to the memory circuit and accesses the program code to execute: obtaining a t-th input image and a t-th reference image, where t is a time index value; determining a first weight map based on the t-th input image and the t-th reference image; using the t-th input image as a guidance image to perform a guided filtering operation on the first weight map to generate a second weight map; and performing a temporal filtering operation on the t-th input image and the t-th reference image based on the second weight map to generate a t-th output image.

### BRIEF DESCRIPTION OF THE DRAWINGS

FIG. 1 is a schematic diagram of an image processing device according to an embodiment of the disclosure.

FIG. 2 is a functional block diagram of the image processor depicted in FIG. 1.

FIG. 3 is a flow chart of an image noise reduction method according to an embodiment of the disclosure.

FIG. 4 is an application scenario diagram of determining the first weight map by the weight determination circuit depicted in FIG. 2.

FIG. 5 is a schematic diagram of a first monotonically increasing function according to an embodiment of the disclosure.

FIG. 6 is a schematic diagram of a second monotonically increasing function according to an embodiment of the disclosure.

FIG. 7 is a schematic diagram of an input image, a first weight map, and a second weight map according to an embodiment of the disclosure.

### DESCRIPTION OF THE EMBODIMENTS

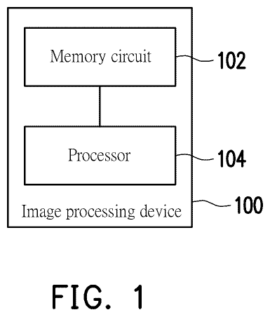

With reference to FIG. 1, FIG. 1 is a schematic diagram of an image processing device according to an embodiment of the disclosure. In different embodiments, an image processing device 100 may be implemented as various smart devices and/or computer devices, for example, but the disclosure is not limited thereto.

In FIG. 1, the image processing device 100 includes a memory circuit 102 and an image processor 104.

The memory circuit 102 is, for example, any form of fixed or movable random access memory (RAM), a read-only memory (ROM), a flash memory, a hard disk drive, or other similar devices, or a combination thereof, which may be used to record a plurality of codes or modules.

The image processor 104 is coupled to the memory circuit 102 and may be a processor for general purposes, a processor for special purposes, a conventional processor, a digital signal processor, a plurality of microprocessors, one or more microprocessors, controllers, microcontrollers and Application Specific Integrated Circuit (ASIC) which are combined to a core of the digital signal processor, a Field Programmable Gate Array (FPGA), any other integrated circuits, a state machine, a processor based on advanced RISC machine (ARM), and similar products.

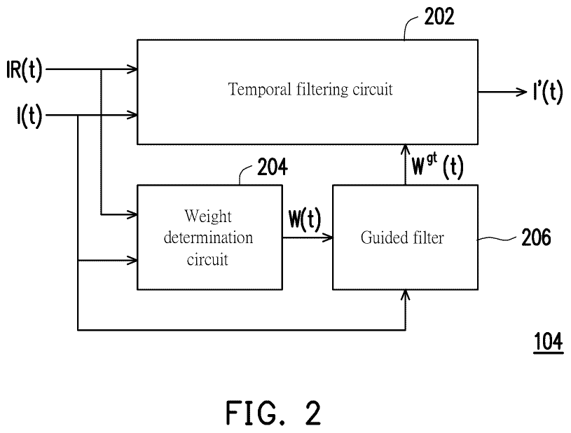

With reference to FIG. 2, FIG. 2 is a functional block diagram of the image processor depicted in FIG. 1. In FIG. 2, the image processor 104 includes a temporal filtering circuit 202, a weight determination circuit 204, and a guided filter 206. The guided filter 206 is coupled between the temporal filtering circuit 202 and the weight determination circuit 204.

In an embodiment of the disclosure, the image processor 104 may access the modules and program codes recorded in the memory circuit 102 to implement the image noise reduction method proposed by the disclosure, the details of which are described in detail below.

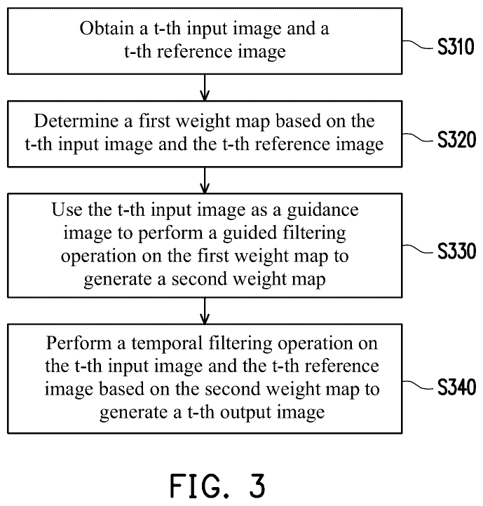

With reference to FIG. 3, FIG. 3 is a flow chart of an image noise reduction method according to an embodiment of the disclosure. The method of the embodiment may be collaboratively executed by each component in the image processing device 100 depicted in FIG. 1. The details of each step in FIG. 3 will be described below with reference to the components shown in FIG. 1 and FIG. 2.

In step S310, the image processor 104 obtains a t-th input image I(t) and a t-th reference image IR(t), where t is a time index value.

In embodiments of the disclosure, the image processor 104 may obtain various images from the considered image source. In different embodiments, the image source is, for example, a monitor that may capture an image of the monitored area in real time and/or a storage space (such as an image database) that stores images to be analyzed and/or processed, but the disclosure is not limited thereto.

In an embodiment of the disclosure, the t-th input image is, for example, a t-th image among a plurality of images obtained by the image processor 104 from the above-mentioned image source.

In addition, the t-th reference image IR(t) is, for example, a reference image corresponding to the t-th input image I(t). In an embodiment, the t-th reference image IR(t) is, for example, a (t−1)-th input image (hereinafter represented by I(t−1)), that is, the preceding input image of the t-th input image I(t), but the disclosure is not limited thereto.

In an embodiment of the disclosure, after obtaining the t-th input image I(t) and the t-th reference image IR(t), the image processor 104 may continue to execute steps S320 to S340 to generate a corresponding t-th output image I′(t). In an embodiment, the t-th output image I′(t) may be used as a reference image corresponding to a (t+1)-th input image (i.e., a (t+1)-th reference image).

Based on the principle of similarity, in some embodiments, the t-th reference image IR(t) may also be a (t−1)-th output image (hereinafter represented by I′(t−1)), that is, the preceding output image of the t-th output image I′(t), but the disclosure is not limited thereto,

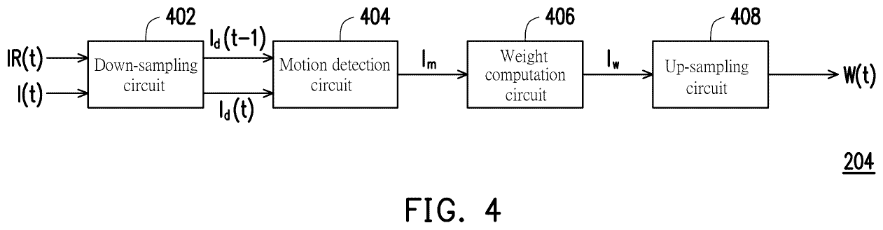

In step S320, the weight determination circuit 204 of the image processor 104 determines a first weight map W(t) based on the t-th input image I(t) and the t-th reference image IR(t). The details of step S320 will be described below with reference to FIG. 4.

With reference to FIG. 4, FIG. 4 is an application scenario diagram of determining the first weight map by the weight determination circuit depicted in FIG. 2.

In FIG. 4, the weight determination circuit 204 includes a down-sampling circuit 402, a motion detection circuit 404, a weight computation circuit 406, and an up-sampling circuit 408 coupled in sequence.

In the embodiment, the down-sampling circuit 402 may down-sample the t-th input image I(t) into a first image Ia(t), and down-sample the t-th reference image IR(t) into a second image Ia(t−1).

In an embodiment, the down-sampling circuit 402 may perform the above-mentioned down-sampling on the t-th input image I(t) and the t-th reference image IR(t) based on a preset down-sampling parameter. For example, assuming that the selected down-sampling parameter is S (for example, 8), the size of the first image I_{d}(t) obtained by down-sampling the t-th input image I(t) is, for example, 1/S² (for example, 1/64) of the t-th input image I(t). Similarly, the size of the second image I_{d}(t−1) obtained by down-sampling the t-th reference image IR(t) is, for example, 1/S² (for example, 1/64) of the t-th reference image IR(t).

Afterwards, the motion detection circuit 404 may determine a motion image Iₘ based on the pixel-by-pixel absolute difference between the first image I_{d}(t) and the second image I_{d}(t−1).

In an embodiment, the motion detection circuit 404 may determine an absolute difference map based on the pixel-by-pixel absolute difference between the first image I_{d}(t) and the second image I_{d}(t−1).

In an embodiment, the pixel at coordinates (i, j) in the absolute difference map may be represented as d_{i,j} (i, j are positive integers), which may, for example, be the absolute difference between the pixel at coordinates (i, j) in the first image I_{d}(t) and the pixel at coordinates (i, j) in the second image I_{d}(t−1).

Afterwards, the motion detection circuit 404 may convert the absolute difference map into the motion image Iₘ based on the first monotonically increasing function (hereinafter represented by f(·)). In an embodiment, the pixel at coordinates (i, j) in the motion image Iₘ may be represented as m_{i,j}, where m_{i,j}=f (d_{i,j}).

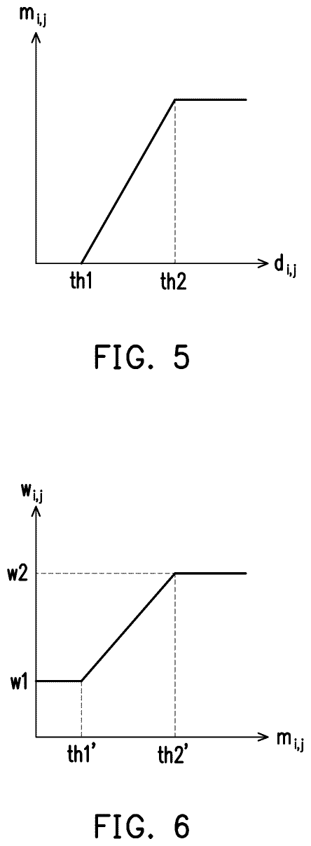

With reference to FIG. 5, FIG. 5 is a schematic diagram of a first monotonically increasing function according to an embodiment of the disclosure. In the embodiment, the designer may select appropriate threshold th1 and threshold th2 according to requirements.

In the scenario of FIG. 5, for d_{i,j} smaller than the threshold th1, the corresponding m_{i,j} is, for example, 0 (or other values that the designer prefers). In addition, for d_{i,j} greater than the threshold th2, the corresponding m_{i,j} is, for example, a fixed value (which may be determined by the designer according to requirements). For d_{i,j} between threshold th1 and threshold th2, the corresponding m_{i,j} may, for example, increase monotonically as d_{i,j} increases, but the disclosure is not limited thereto.

Afterwards, the motion detection circuit 404 may convert the motion image Iₘ into a first reference weight map I_{w}.

In an embodiment, the weight computation circuit 406 may convert the motion image Iₘ into the first reference weight map I_{w} based on the second monotonically increasing function (hereinafter represented by g(·)). In an embodiment, the pixel at coordinates (i, j) in the first reference weight map I_{w} may be represented as w_{i,j}, where w_{i,j}=g(m_{i,j}).

With reference to FIG. 6, FIG. 6 is a schematic diagram of a second monotonically increasing function according to an embodiment of the disclosure. In the embodiment, the designer may select appropriate threshold th1′ and threshold th2′ according to requirements.

In the scenario of FIG. 6, for m_{i,j} smaller than the threshold th1′, the corresponding w_{i,j} is, for example, a value w1 (which may be determined by the designer according to requirements). In addition, for m_{i,j} greater than the threshold th2′, the corresponding w_{i,j} is, for example, a value w2 (which may be determined by the designer according to requirements). For m_{i,j} between the threshold th1′ and the threshold th2′, the corresponding w_{i,j} may, for example, increase monotonically as m_{i,j} increases, but the disclosure is not limited thereto.

Next, the up-sampling circuit 408 may up-sample the first reference weight map I_{w} into the first weight map W(t).

In an embodiment, the down-sampling parameter (i.e., S) corresponding to the first image I_{d}(t) and the second image I_{d}(t−1) is the reciprocal (for example, 1/S) of the up-sampling parameter corresponding to the first weight map W(t).

Thereby, the first weight map W(t) obtained by up-sampling the first reference weight map I_{w} may have the same size as the t-th input image I(t) and the t-th reference image IR(t).

With reference to FIG. 2 again, after the weight determination circuit 204 determines the first weight map W(t), in step S330, the guided filter 206 of the image processor 104 uses the t-th input image I(t) as a guidance image to perform a guided filtering operation on the first weight map W(t) to generate a second weight map W^{gf}(t). In an embodiment, the second weight map W^{gf}(t) may be represented as “W^{gf}(t)=Guided_Filtering(I(t), W(t))”.

In an embodiment, the pixel at coordinates (i, j) in W^{gf}(t) may be represented as

$${W}_{i , j}^{g f} ( t ) ,$$

for example.

In an embodiment,

$${W}_{i , j}^{g f} ( t )$$

may be calculated based on the following equation:

$${W}_{i , j}^{gf} ( t ) = {\overline{a}}_{i , j} {I}_{i , j} ( t ) + {\overline{b}}_{i , j} , \qquad ( 1 )$$

where

$${\overline{a}}_{i , j} = \frac{1}{\vert ω \vert} {\sum }_{k ∈ {ω}_{i , j}} {a}_{k} and {\overline{b}}_{i , j} = \frac{1}{\vert ω \vert} {\sum }_{k ∈ {ω}_{i , j}} {b}_{k} .$$

In some embodiments,

$${a}_{k} = \frac{\frac{1}{\vert ω \vert} {\sum }_{( x , y ) ∈ {ω}_{k}} {I}_{x , y} ( t ) {W}_{x , y} ( t ) - {μ}_{k} {\overline{p}}_{k}}{{σ}_{k}^{2} + ε}$$

and bₖ=p̅ₖ-αₖμₖ.

The calculation methods and definitions of each parameter related to equation (1) may be summarized as the contents of Table 1 below, for example.

TABLE 1

| Para- | |
|---|---|
| meters | Definition |
| aₖ | coefficients of the window ωₖ comprising (i, j) |
| bₖ | coefficients of the window ωₖ comprising (i, j) |
| ω_{i,j} | guidance image I(t) in the window centered at (i, j) |
| \|ω\| | total number of pixels in the window ωₖ |
| ${σ}_{k}^{2}$ | variance of the guidance image in the window ωₖ |
| μₖ | average number of pixels of the guidance image in the window |
| | ωₖ |
| p̅ₖ | weighted average of the first weight map W(t) in the window ωₖ |
| ε | regularization parameter |

In other embodiments, regarding the relevant details of the guided filtering operation, reference may be made to the literature of “guided image filtering” and will not be repeatedly described herein.

In step S340, the temporal filtering circuit 202 of the image processor 104 performs a temporal filtering operation on the t-th input image I(t) and the t-th reference image IR(t) based on the second weight map W^{gf}(t) to generate the t-th output image I′(t).

In an embodiment, the pixel at coordinates (i, j) in the t-th output image I′(t) is represented by

$${1}_{i , j}^{′} ( t ) ,$$

which may be calculated, for example, by the following equation:

$${I}_{i , j}^{′} ( t ) = {I}_{i , j} ( t ) \times {W}_{i , j}^{g f} ( t ) + {IR}_{i , j} ( t ) \times [ 1 - {W}_{i , j}^{gf} ( t ) ] , \qquad equation ( 2 )$$

where I_{i,j}(t) is the pixel at coordinates (i, j) in the t-th input image I(t), IR_{i,j}(t) is the pixel at coordinates (i, j) in the t-th reference image IR(t), and

$${W}_{i , j}^{g f} ( t )$$

is the pixel at coordinates (i, j) in the second weight map W^{gf}(t).

As mentioned before, in different embodiments, the t-th reference image IR(t) may be the (t−1)-th input image I(t−1) or the (t−1)-th output image I′(t−1).

Based on this, in the embodiment where the t-th reference image IR(t) is the (t−1)-th input image I(t−1), equation (2) may be rewritten as the following equation (3), for example:

$${I}_{i , j}^{′} ( t ) = {I}_{i , j} ( t ) \times {W}_{i , j}^{g f} ( t ) + {I}_{i , j} ( t - 1 ) \times [ 1 - {W}_{i , j}^{gf} ( t ) ] , \qquad ( 3 )$$

where

$${W}_{i , j}^{g f} ( t ) ϵ [ 0. , 1. ] ,$$

and I_{i,j}(t−1) is the pixel at coordinates (i, j) in the (t−1)-th input image I(t−1).

In addition, in the embodiment where the t-th reference image IR(t) is the (t−1)-th output image I′(t−1), equation (2) may be rewritten as the following equation (4), for example:

$${I}_{i , j}^{′} ( t ) = {I}_{i , j} ( t ) \times {W}_{i , j}^{g f} ( t ) + {I}_{i , j}^{′} ( t - 1 ) \times [ 1 - {W}_{i , j}^{gf} ( t ) ] ,$$

where

$${W}_{i , j}^{g f} ( t ) ϵ [ 0. , 1. ] , and {I}_{i , j}^{′} ( t - 1 )$$

is the pixel at coordinates (i, j) in the (t−1)-th output image I′(t−1).

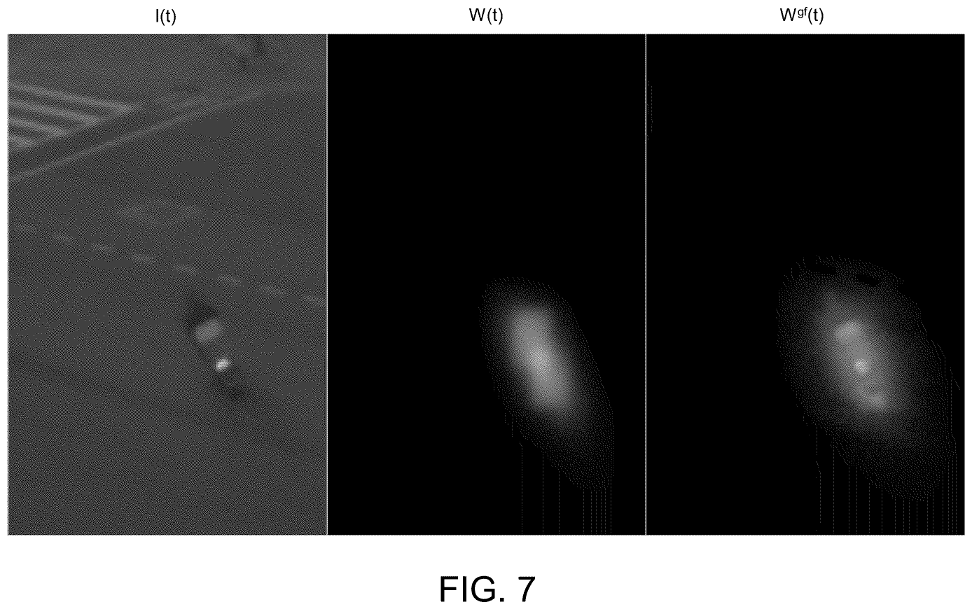

With reference to FIG. 7, FIG. 7 is a schematic diagram of an input image, a first weight map, and a second weight map according to an embodiment of the disclosure.

In FIG. 7, the t-th input image I(t) considered is, for example, an image of a motorcyclist riding a motorcycle, and the image processor 104 may execute step S320 and step S330 of FIG. 2 accordingly to generate the first weight map W(t) and a second weight map W^{gf}(t).

As can be seen from FIG. 7, compared with the first weight map W(t), the pixels corresponding to the motion area in the second weight map W^{gf}(t) are more prominent, and the noise corresponding to the pixels in the stationary area is more effectively suppressed.

In other words, the second weight map W^{gf}(t) may accurately present the subtle movement amount of the moving object in the detected t-th input image I(t), thereby improving the subsequent TNR effect.

From another point of view, the second weight map W^{gf}(t) generated based on the concept of guided filtering may better emphasize the pixels corresponding to the motion area in the t-th input image I(t). Thereby, when the second weight map W^{gf}(t) is used for temporal filtering operation, a better TNR effect may be achieved accordingly.

In some embodiments, after generating the t-th output image I′(t), the image processor 104 may perform object detection or other subsequent image analysis on the t-th output image I′(t). deal with. Since the noise in the t-th output image I′(t) is lower, the performance of subsequent image analysis/processing may be improved.

To sum up, the means of the embodiment of the disclosure may accurately detect the subtle movements of moving objects in the image, and significantly improve the TNR effect of the image. The method of the embodiment of the disclosure improves the accuracy of motion detection through the guided filter, so that it may effectively capture the subtle movements of objects, thus enabling excellent noise reduction performance for stationary areas in the detected image and avoiding ghost effects on moving objects (especially objects with subtle movements) in the detected image.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. An image noise reduction method, executed by an image processing device, comprising:
obtaining a t-th input image and a t-th reference image, wherein t is a time index value;
determining a first weight map based on the t-th input image and the t-th reference image;
using the t-th input image as a guidance image to perform a guided filtering operation on the first weight map to generate a second weight map; and
performing a temporal filtering operation on the t-th input image and the t-th reference image based on the second weight map to generate a t-th output image.

2. The method according to claim 1, wherein the t-th reference image comprises a (t−1)-th input image or a (t−1)-th output image.

3. The method according to claim 1, wherein determining the first weight map based on the t-th input image and the t-th reference image comprises:
down-sampling the t-th input image into a first image;
down-sampling the t-th reference image into a second image;
determining a motion image based on a pixel-by-pixel absolute difference between the first image and the second image;
converting the motion image into a first reference weight map; and
up-sampling the first reference weight map into the first weight map.

4. The method according to claim 3, wherein determining the motion image based on the pixel-by-pixel absolute difference between the first image and the second image comprises:
determining an absolute difference map based on the pixel-by-pixel absolute difference between the first image and the second image; and
converting the absolute difference map into the motion image based on a first monotonically increasing function.

5. The method according to claim 3, wherein converting the motion image into the first reference weight map comprises:
converting the motion image into the first reference weight map based on a second monotonically increasing function.

6. The method according to claim 3, wherein a down-sampling parameter corresponding to the first image and the second image is a reciprocal of an up-sampling parameter corresponding to the first weight map.

7. The method according to claim 1, wherein a pixel at coordinates (i, j) in the t-th output image is represented by
$${I}_{i , j}^{′} ( t ) ,$$
$${I}_{i , j}^{′} ( t ) = {I}_{i , j} ( t ) \times {W}_{i , j}^{gf} ( t ) + {IR}_{i , j} ( t ) \times [ 1 - {W}_{i , j}^{gf} ( t ) ]$$
I_{i,j}(t) is a pixel at coordinates (i, j) in the t-th input image, IR_{i,j}(t) is a pixel at coordinates (i, j) in the t-th reference image, and
$${W}_{i , j}^{g f} ( t )$$
is a pixel at coordinates (i, j) in the second weight map.

8. An image processing device, comprising:
a memory circuit, storing a program code; and
an image processor, coupled to the memory circuit, and accessing the program code to execute:
obtaining a t-th input image and a t-th reference image, wherein t is a time index value;
determining a first weight map based on the t-th input image and the t-th reference image;
using the t-th input image as a guidance image to perform a guided filtering operation on the first weight map to generate a second weight map; and
performing a temporal filtering operation on the t-th input image and the t-th reference image based on the second weight map to generate a t-th output image.
